(19) United States
(12) Patent Application Publication
(10) Pub. No.: US 2002/0077958 A1
(43) Pub. Date: Jun. 20, 2002

(54) Implementation of a supply-based management system in a network environment

(76) Inventors: Gregory Gardner, Hayward, Alameda, CA (US); Amrit Jassal, Morgan Hill, CA (US); Agrawal Bharti, Palo Alto, CA (US); Narayanaswamy Suresh, Fremont, CA (US); Trung Dinh, San Jose, CA (US)

Correspondence Address: SAWYER LAW GROUP LLP, P.O. Box 51418, Palo Alto, CA, 94303, US

(21) Appl. No.: 09/742,848

(22) Filed: Dec. 20, 2000

(51) Int. Cl. G06F 17/60

(52) U.S. Cl. 705/37

(57) ABSTRACT

The present invention provides an implementation of a supply-based management system in a network environment. The system includes a server, which includes a plurality of business process entity beans and a notification manager. The plurality of business process entity beams includes a request-for-quotation process entity bean, a quotation process entity bean, and a purchase order process entity bean. The system also includes a front-end, which includes: a user interface, a controller coupled to the user interface, and a business process router coupled to the controller. In a preferred embodiment, the front end architecture includes Java server pages, a controller, and a business process router. The server side architecture includes a plurality of business processes, which are implemented by a plurality of Enterprise JavaBeans, and a notification manager as a messaging daemon. The plurality of Enterprise JavaBeans implement, among others, the request-for-quotation, the quotation, and the purchase order processes. By implementing the supply-based management system in a network environment, the efficiency of the plurality of business processes is increased.

### FIELD OF THE INVENTION

The present invention relates to supply-based management, and more particularly to an implementation of a supply-based management system in a network environment.

### BACKGROUND OF THE INVENTION

Known supply-based management techniques relate to selection and maintenance of relationships with suppliers, for a purchasing company. The purchasing company desires to manage its relationships with those other companies that supply the purchasing company with goods. It would be advantageous for the purchasing company to obtain both the best price and the best value from its suppliers. Evaluation of best value can be a complex issue, involving parameters such as product reliability, order scalability, product line flexibility or variety, time from order to delivery and other factors responsive to decisions made by the purchasing company.

A first problem in the known art is that supply-based management techniques use substantial resources at the purchasing company, particularly individuals skilled at locating, evaluating and negotiating with suppliers on a global level. These substantial resources can include, without limitation, substantial effort, allocation of personnel, money, and time, all used to determine which of those suppliers provide best value to the purchasing company and to develop long term, mutually beneficial relationships with them. Related to this problem is the similar problem in the known art that supply-based management techniques are best applied when the purchasing company has substantial purchasing requirements, such as if the purchasing company is relatively large or has a relatively large number of suppliers.

A second problem in the known art is that supply-based management techniques often involve a continuing relationship between the purchasing company and its suppliers. Thus, the purchasing company would find it advantageous to apply supply-based management techniques on an ongoing basis, rather than for individual, or sporadic, purchasing needs. Related to this problem is the similar problem in the known art that purchasing companies often desire continuous development of their products or product lines, and thus often desire continuous development of the goods supplied to them, including preferred product attributes contributed by suppliers desiring to participate with the purchasing company in its product development.

A third problem in the known art is that supply-based management techniques are advantageous when applied to a relatively larger pool of possible suppliers. Thus, the purchasing company would find it advantageous to apply supply-based management techniques to a set of possible suppliers, where that set is relatively disparate and possibly large in number. This problem is particularly exacerbated when the set of possible suppliers includes companies in other countries or other cultures, or involves the use of unfamiliar languages, standards of measurement, or different supply channels for distribution of goods.

A fourth problem in the known art is that known supply-based management techniques are not readily applicable to suppliers in search of purchasing companies that provide best value to the suppliers. Evaluation of best value to suppliers can be a complex issue, quite different from that evaluation of purchasing companies, and can involve parameters such as payment reliability, order regularity, product line fit with the supplier, requirements for reliability, time allowed for delivery, cost of account management and opportunity for new business.

A fifth problem in the known art is that supply-based management techniques predominantly involve extensive human interaction between different suppliers on behalf of the purchasing company and vice versa. Such human interaction is inefficient and prone to human errors.

A sixth problem in the known art is that supply-based management techniques are traditionally “offline” mechanisms, which are slow. The workflow from submitting a Request for Quotation until the actual issue of a Purchase Order involves significant time and human capital overhead.

Accordingly, there exists a need for an implementation of a supply-based management system in a network environment. The present invention addresses such a need.

### SUMMARY OF THE INVENTION

The present invention provides an implementation of a supply-based management system in a network environment. The system includes a server, which includes a plurality of business process entity beans and a notification manager. The plurality of business process entity beams includes a request-for-quotation process entity bean, a quotation process entity bean, and a purchase order process entity bean. The system also includes a front-end, which includes: a user interface, a controller coupled to the user interface, and a business process router coupled to the controller. In a preferred embodiment, the front end architecture includes Java server pages, a controller, and a business process router. The server side architecture includes a plurality of business processes, which are implemented by a plurality of Enterprise JavaBeans, and a notification manager as a messaging daemon. The plurality of Enterprise JavaBeans implement, among others, the request-for-quotation, the quotation, and the purchase order processes. By implementing the supply-based management system in a network environment, the efficiency of the plurality of business processes is increased.

### BRIEF DESCRIPTION OF THE FIGURES

FIG. 1 shows a block diagram of a system for application of supply-based management and related techniques.

FIG. 2 shows a data flow diagram of the system for application of supply based managed and related techniques.

FIG. 3 shows a preferred embodiment of a network architecture which implements the supply-based management system in accordance with the present invention.

FIG. 4 shows in more detail the WebController of the network architecture in accordance with the present invention.

FIG. 5 is a flowchart illustrating the Request For Quotation process implemented by the RFQ Entity Beam, RFQ Data Beans, and a RFQ business process engine, in the network architecture in accordance with the present invention.

FIG. 6 is a flowchart illustrating the Quotation process implemented by the Quote Entity Bean, Quotation Data Beans, and a Quotation business process engine, in the network architecture in accordance with the present invention.

FIG. 7 is a flowchart of the Purchase Order process implemented by the PO Entity Bean, PO Data Beans, and a PO business process engine, in the network architecture in accordance with the present invention.

FIG. 8 shows a preferred embodiment of the Notification Manager in the network architecture in accordance with the present invention.

### DETAILED DESCRIPTION

The present invention provides an implementation of a supply-based management system in a network environment. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

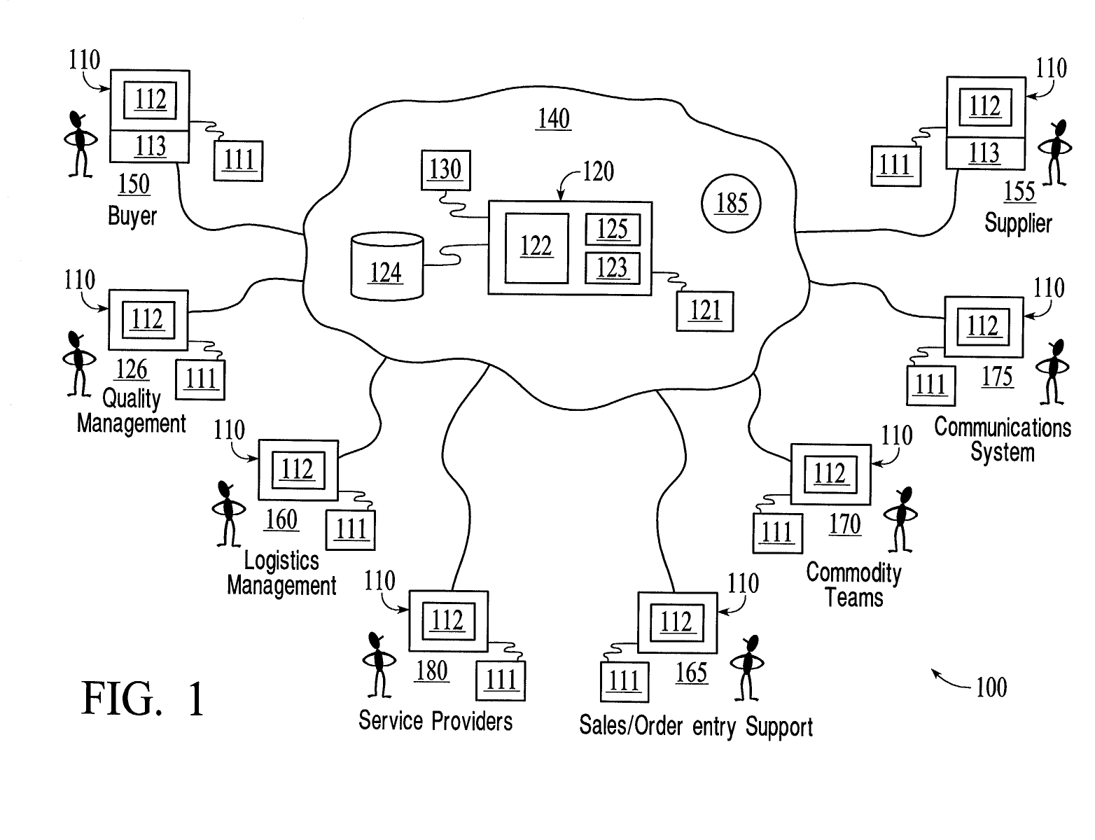

To more particularly describe the features of the present invention, please refer to FIGS. 1 through 8 in conjunction with the discussion below.

As used herein, use of the following terms refer or relate to aspects of the invention as described below.

supply-based management—in general, “supply-based management” is a methodology for developing and managing a set of strategic, best value global suppliers. This methodology is used by the manufacturers of goods wherein supplier relationships are viewed as an important source of value because of the strategic role procurement of materials and components plays from product development through post-sale service.

best-value—in general, “best value” refers to a set of characteristics of specific manufactured goods that gives them optimal value to the buyer. This characteristic is not necessarily limited to the quality of price of the goods, but may relate to scalability, ease of procurement, product line flexibility, and many other factors of value exchange inherent in the supplier-buyer relationship.

supplier—in general, “supplier” refers to an entity that provides goods in return for some valuable consideration.

buyer—in general, “buyer” refers to an entity that acquires goods in return for some valuable consideration.

“client” and “server”—in general, the terms “client” and “server” refer to relationships between the client and the server, not necessarily to particular physical devices.

“service provider”—in general, “service provider” refers to any third party entity that provides logistics, qualification of suppliers or other services that facilitate the supplier-buyer relationship.

“commodity team”—in general “commodity team” refers to an entity that identifies, qualifies and manages a set of global, best value suppliers on behalf of buyers and provides them with market leadership.

“client device” and “server device”—in general, the phrase “client device” includes any device taking on the role of a client in a client-server relationship (such as an HTTP web client and web server). There is no particular requirement that any client devices must be individual physical devices, they can each be a single device, a set of cooperating devices, a portion of a device, or some combination thereof. As used herein, the phrase “server device” includes any device taking on the role of a server in a client-server relationship. There is no particular requirement that server devices must be individual physical devices; they can each be a single device, a set of cooperating devices, a portion of a device, or some combination thereof.

FIG. 1 shows a block diagram of a system for application of supply-based management and related techniques.

A system 100 includes a set of client devices 110, one or more server devices 120 and a communication link 140.

A client device 110 is used by some or all of the following parties: a buyer 150, a supplier 155, quality management 126, a logistics management system 160, order entry-sales support 165, a communications system 175 or server providers 180.

Each client devices 110 includes an input element 111, a presentation element 112 and a local memory 113. Both the buyer 150 and supplier 155 provide data concerning their respective sides of a transaction by manipulating the input element 111 included in their respective client devices 110. Both the buyer 150 and supplier 155 enter data regarding the nature of desired transactions such as the type of commodity, volume, possible terms, delivery dates and other aspects of a transaction that can be used to develop best value.

In a preferred embodiment, the client services 110 each include a general-purpose computer, such as a laptop or workstation. However, the client devices 110 can also include (either alone or in conjunction with a laptop or workstation), a hand-held calendar (such as “Palm Pilot” or other hand-held device), a portable computer, a special purpose computer, a cellular telephone or other telephonic device, a web server acting as the agent for a user, or another device. In alternative embodiments, the client devices 110 may also include any other device disposed for performing all or some functions described herein.

The server device 120 includes an input element 121, a presentation element 122, a local memory 123, a database 124, a web site 185 and a computer program 125 that can be accessed by the client devices 110 using communications link 140.

The location, the type of device, and the nature of the connection of the client devices 110 to the web site 185 can each differ between pairs of connection sessions between the client devices 110 and the web site 185.

Other parties to the transaction (for example, quality management 126, logistics management 160, sales/order entry support 165, commodity teams 170, a communications system 175 or service providers 180) each use their respective client devices 110 to access the server 120. These parties provide information and (in some instances) added value services, so as to facilitate transactions between prospective buyers 150 and suppliers 155 and identify matches for buyers and suppliers so that both the buyer and supplier receive the best value from any resulting transaction. For example, among other benefits, (1) suppliers can acquire new sales and lower account management costs and (2) buyers can acquire pre-qualified goods and services from a global base of pre-qualified bets value suppliers. Taken together, all of the aforementioned parties to a transaction provide an integrated array of pre-qualified best value resources for the implementation of supply-based management techniques.

Input from all these parties may be stored on the database 124. The database 124 not only holds information relevant to finding the best value for each buyer 150 and supplier 155, but also includes information on the relative success of each transaction. Selected information from the database 124 is used to generate an individual scorecard 130 for each supplier 155, logistics management system 160 and other parties involved in facilitating the transaction. These scorecards 130 are used to evaluate the results of transactions and identify areas for improvement. Buyers 150 may view them at a web site 185 so they may optimize their own acquisition strategies, with the continual involvement of the commodity team 170.

The communication link 140 includes any technique for sending information between the set of clients 110 used by the various parties and the server 120. In a preferred embodiment, the communication link 140 includes a computer network, such as an Internet, intranet, extranet, or a virtual private network. In alternative embodiments, the communication link 140 can include a direct communication line, a switched network such as a telephone network, or any combination thereof, including a fax machine.

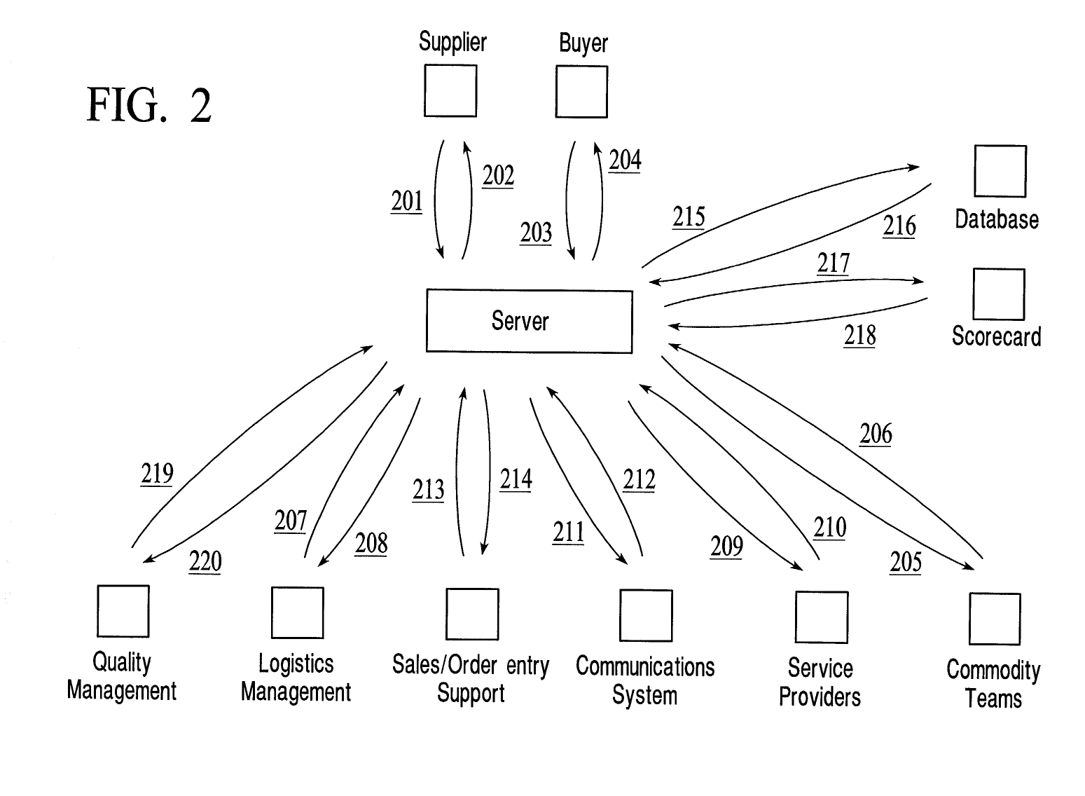

FIG. 2 shows a data flow diagram of the system 100 in operation.

A flow path 201 shows the flow of information from the supplier 155 to the server 120. This information may include data on quality of commodity, commodities to be included in the database 124, terms, anticipated product development, total costs, regionalization, product descriptions, and other factors related to the nature and relative availability of the commodity.

A flow path 202 shows the flow of information from the server 120 to the supplier 155. This information may include data on prospective buyers 150, feedback from the commodity teams 170, purchase orders, transportation tracking reports, buyer manufacturing specifications, scorecard 130 results and other related information.

The flow of data from the server 120 to the supplier 155 provides the supplier 155 with a more efficient way of obtaining numerous benefits than the prior art permits. Specifically, the supplier 155 looks to a single source for many services that have already been evaluated (that is, they have a scorecard 130) rather than looking to multiple sources of possibly unknown quality. The benefits to the supplier 155 that result from data included in this flow path include the ability to look to a single source for acquiring new sales, achieving lowest costs for sales management, orientation and training materials, information from industry experts, industry associations and many others.

A flow path 203 shows the flow of information from the buyer 150 to the server 120. This information may include purchase orders, descriptions of goods desired, volume desired, acceptable terms, feedback on a supplier 155, information about transportation problems and anticipated future needs. The communication link 140 and server 120 can be used by other parties who need information contained in this flow path. For example, if flow path 203 contains information from a buyer 150 concerning a late shipment, this information will be subsequently transmitted from the server 12 to a logistics management system 160 who will track the shipment and assure it's arrival.

A flow path 204 shows the flow of information from the server 120 to the buyer 150. This information may include order confirmations, data on prospective suppliers 155, feedback from the commodity teams 170, volume requirements, transportation tracking reports, manufacturing specifications, scorecard 130 results and other related information. This flow of information enables the buyer 150 to take advantage of an integrated platform for using supply-based management techniques. The flow of information from server 120 to buyer 150 provides buyers with an integrated array of options for purchasing because it offers them access to a strategic, global, integrated platform of pre-qualified resources and choices not available in the prior art.

A flow path 205 shows flow of information from the server 130 to the commodity teams 170. This information may include data on input from buyers 150, suppliers 155, benchmarking partners and service provides 180 from around the world. The commodity teams 170 analyze this data with respect to identifying the best values for buyers 150 and generates plans for enabling the buyer 150 to acquire these commodities.

A flow path 206 shows the flow of information from the commodity teams 170 to the server 120. This information may include information for the supplier 155 regarding the goals of the commodity teams 170, action plans, information from product value roadmapping sessions with suppliers 155 and information destined for the web site 185, the database 124 or scorecards 130.

A flow path 207 shows the flow of information from the logistics management system transportation specialist 160 to the server 120. This information may include logistical information, transit evaluations, data on local and international transit providers and related information to update the database 124 and scorecards 130. Some select portion of this information (such as information concerning data on a particular shipment) may ultimately be sent to the web site 185 where parties to a transaction may check the status of a shipment.

A flow path 208 shows the flow of information from the server 120 to the logistics management system transportation specialist 160. This information may include data on buyers 150, suppliers 155, desired shipping conditions for a particular shipment, data as to whether a shipment was successfully completed with respect to time and damaged goods, scorecard 130 reports, updates on the activities of service providers 180 and related information.

A flow path 209 shows the flow of information from the server 120 to the service provider 180. This information may include service requests, suggested modifications of contract terms, feedback from buyers 150 and similar data such as required to facilitate the involvement and contribution of service providers.

A flow path 210 shows the flow of information from a service provider 180 to the server 120. This information may include data on the types of service available, the qualifications of a service provider, costs, regional issues, data that describes an ongoing activity and other data related to the service.

A flow path 211 shows the flow of information from the server 120 to the communications system analyst 175. This may include data on timeliness, action management, effectiveness, communication failures and complaints.

A flow path 212 shows the flow of information from the communications system 175 to the server 120. The communications system 175 reviews all the data described in FIG. 211 and generates plans for improved communication, which are sent to the server 120.

A flow path 213 shows the flow of information from the sales/entry order support 165 to the server 120. This flow path includes all information required to facilitate the bidding and ordering process. For example, it may include a bid request, bidding, negotiations, purchase order placement and acknowledgment thereof.

A flow path 214 shows the flow of information from the server 120 to the sales/order entry support 165. This flow path includes all the information contained in flow path 213, as well as data on purchase requirements, purchase history, quality history, data from the database 124 and scorecards 130.

A flow path 215 shows the flow of information from the server 120 to the database 124. Information in this flowpath may include any of the information described above. The database 124 provides a history of each transaction and a profile of every entity in the stream of commerce. This data is used to evaluate entities in the chain of commerce and generate scorecards 130.

A flow path 216 shows the flow of information from the database 124 to the server 120. This information may include any of the information described above. This may be used in data mining, benchmarking, strategic sourcing and other activities.

A flow path 217 shows the flow of information from the server 120 to the scorecard 130. This information may include data on how well the suppliers 155, logistics management system 160 and other parties to a transaction performed in any transaction. This information is used to create a system to evaluate suppliers 155, service providers 180 and other relevant parties who facilitate a transaction.

A flow path 218 shows the flow of information from the scorecard 130 to the server 120. This information may include any of the data described with respect to flow path 217. Buyers 150, suppliers 155, logistics management 160 and service providers 180 use the data contained in the flow path 218. It enables them to evaluate the past performance of prospective business partners. Scorecards 130 are accessible to both buyers 150 and suppliers 155 and others in the chain of commerce by visiting a dedicated web site 185.

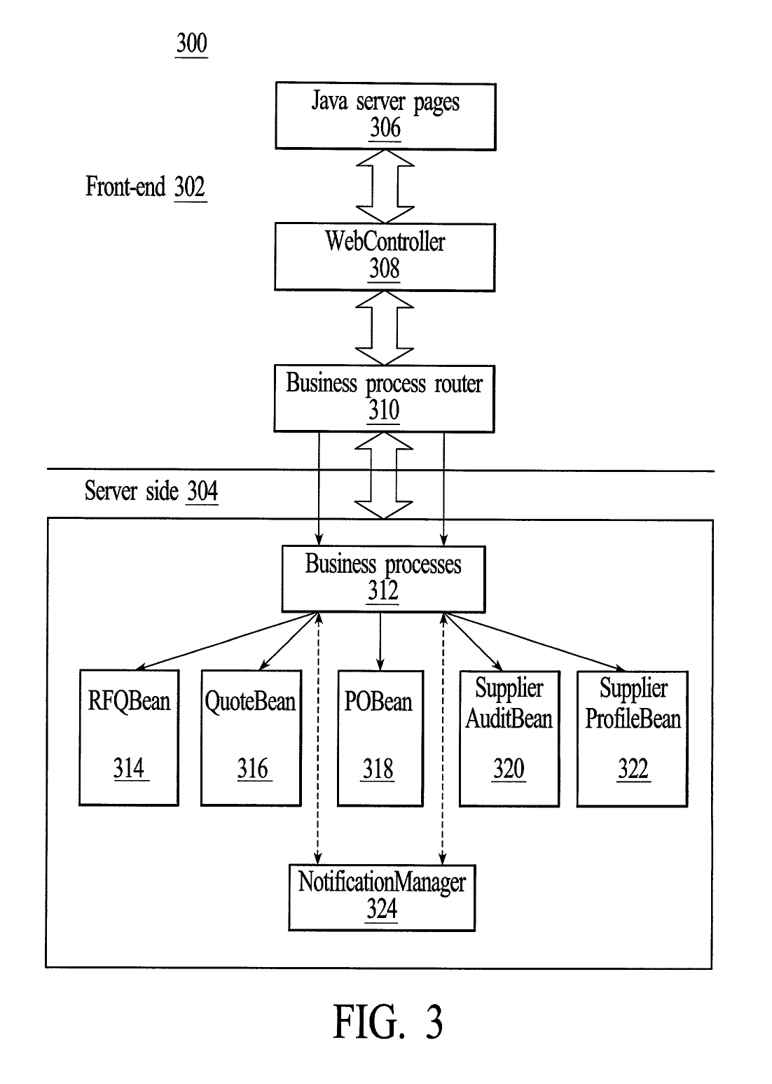

FIG. 3 shows a preferred embodiment of a network architecture which implements the supply-based management system- in accordance with the present invention. The architecture 300 comprises a front end architecture 302 and a server side architecture 304. In the preferred embodiment, the network architecture 300 is implemented in the Internet environment, through web-based applications, using an open standard, such as Java™. In the preferred embodiment, the front end architecture 302 is implemented at the server 120, from where different client applications access one or more business functions through a graphical user interface (GUI). Such a GUI manifests at client systems through Java Server Pages 306 (JSP) when access to the server 120 is granted. The server side architecture 304 is also implemented primarily at the server 120. The front end architecture 302 comprises the JSP 306, a WebController 308, and a Business Process Router 310. The server side architecture 304 comprises business processes 312, which are implemented by a plurality of Enterprise JavaBeans 314-322 (EJB). The server side architecture 304 also comprises a Notification Manager 324 which functions as a messaging daemon. The front end architecture 302 and the server side architecture 304 are described further below.

In the front end architecture 302, the JSPs 306 are documents that support static as well as dynamic content. Static documents are typical of pages based on Hypertext Markup Language (HTML). JSPs 306 provide the flexibility to support such content that would otherwise be specified in a HTML page. In addition, it enables page contents to be updated dynamically. The JSP 306 signify the presentation layer of the architecture 300 and act as the primary means of interface between the parties of a transaction and the web site 185 (FIG. 1). Specifically, the JSPs 306 represent the Graphical User Interface (GUI) component of the web site 185.

The WebController 308 is a data broker. It transfers data from the front-end architecture 302 to the server side architecture 304 and vice versa. Functions performed by the WebController 308 comprises: collecting data from the front-end architecture 302; delegating the business action to be performed, along with the data, to the server side architecture 304; and collecting processed data from the server side architecture 304.

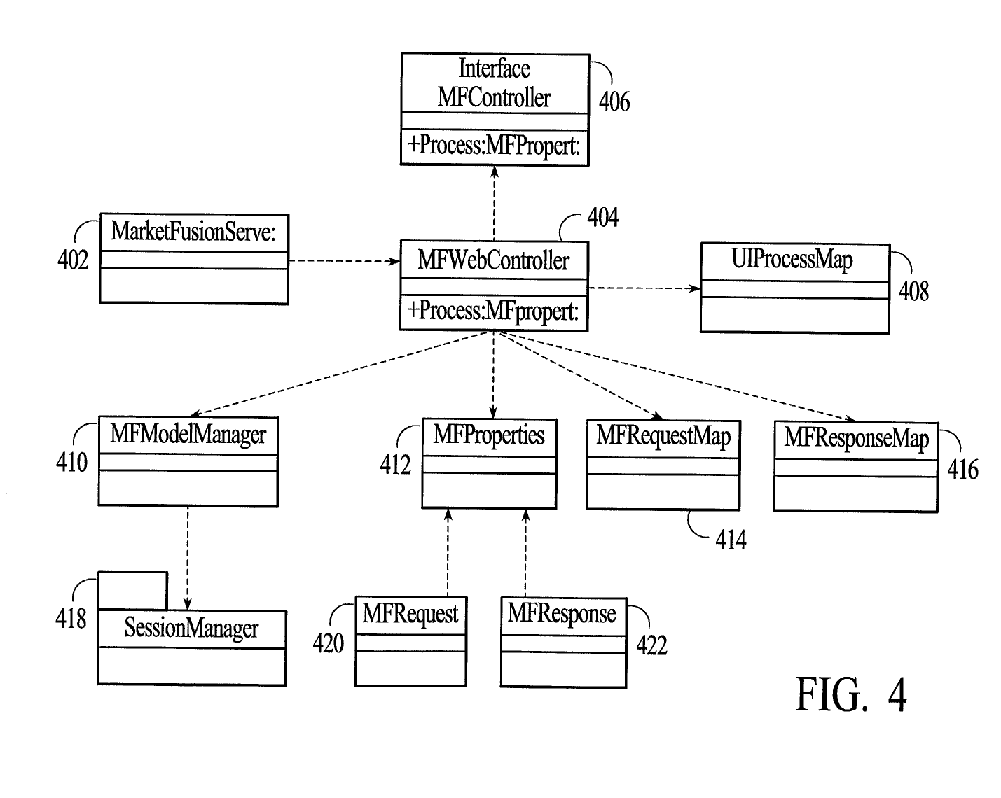

FIG. 4 shows in more detail the WebController 308 of the network architecture in accordance with the present invention. FIG. 4 illustrates a design model of the WebController 308, as opposed to a functional illustration. In the preferred embodiment, the WebController 308 comprises a MarketFusionServlet 402, which is a trigger point for the WebController 308. The actions invoked by a party to a transaction are captured by the MarketFusionServlet 402. The MarketFusionServlet 402 initializes the WebController 308, which in turn transfers the data as generic property objects.

The core part of the WebController 308 functionality is implemented as a Java class: MFWebController 404. The WebController 308 transfers data to and from the front-end architecture 302 or the server side architecture 304 as a set of generic property objects: MFRequest 420 and MFResponse 422. These objects, 414 and 416, represent the web site's ‘request’ and ‘response’ properties, respectively. A request property is initiated when a party invokes an action. A response property is the result of such an action once processed. The WebController 308 controls the manner in which the input and output content are viewed via the interface 406. In essence, the WebController 308 controls the interaction between the ‘view’ and the server side architecture 304. In the process, the WebController 308 uses two mapping mechanisms: MFRequestMap 414 and MFResponseMap 416. MFRequestMap 414 converts the party actions to an appropriate representation that is understandable by the server side architecture 304 business processes 312. The MFResponseMap 416 converts the business results to the corresponding view where the -response is displayed. In addition, the WebController 308 uses a user interface specific map, UIProcessMap 408, that essentially packages data retrieved from the JSPs 306 to a form accessible to the business processes 312.

The Business Process Router 310 identifies the process to which the incoming data (properties) are to be passed for processing. This is represented as SessionManager 418 in FIG. 4. The Business Process Router 310 receives the input property sent by the WebController 308 and maps the receiving action to its corresponding business process through a process map. MFProperties 412 is a super-set of the generic property set represented by MFRequest 420 and MFResponse 422 objects. The latter objects are derivations of this parent object which entails access to all methods that characterize the parent. In addition, the child objects can have their own methods specific to a given processing function. A key part of the WebController 308 is the MFModelManager 410. This object delegates key processing actions of the WebController 308. It provides a layer of indirection through such delegation, and allows for other client applications to seamlessly use the WebController 308.

The server side architecture 304 may be divided into two broad categories: transaction sub-system, and non transaction sub-system. These two sub-systems define the business processes 312 that govern the operational functionality of the web site 185. Each sub-system is in turn invoked and managed by relevant business processes 312 as identified by the business process router 310. The components in the respective sub-systems are implemented as EJBs 314-322.

In accordance with the Enterprise JavaBean specification by Sun Microsystems, Inc.™, the EJBs 314-322 are broadly divided into two categories: session beans and entity beans. Session beans are further divided into ‘stateless’ session beans and ‘stateful’ session beans. The scope of a given session is characterized by the duration and path which the party sets for himself/herself from the time he/she is logged on until logging off from the web site 185. A stateless session bean does not maintain any conversational state between different pages in a given session. In other words, it is devoid of any state information. A stateful session bean, on the other hand, maintains conversational state between different invocations/actions in a given session.

Entity beans are also divided into two types: bean-managed persistence entity beans, and container managed persistence entity beans. In bean-managed persistence, the onus of persisting stored information in a bean resides on the entity bean representing that stored in a database. As such, all code necessary for persistence management must be implemented in the entity bean. However, for container-managed persistence, it is enough to specify what fields to be persisted in an external descriptor file, and the container which hosts the entity bean automatically persists such information to/from the database. Session and entity beans are known in the art and will not be further described here.

In the server side architecture 304 in accordance with the present invention, the transaction sub-system comprises three main processes that define the over-all transactions that can be carried out on the web site 185. These processes include: Request-for-Quotation (RFQ), Quotation, and Purchase Order (PO). Each process is implemented with Entity Beans with bean-managed persistence, as described below.

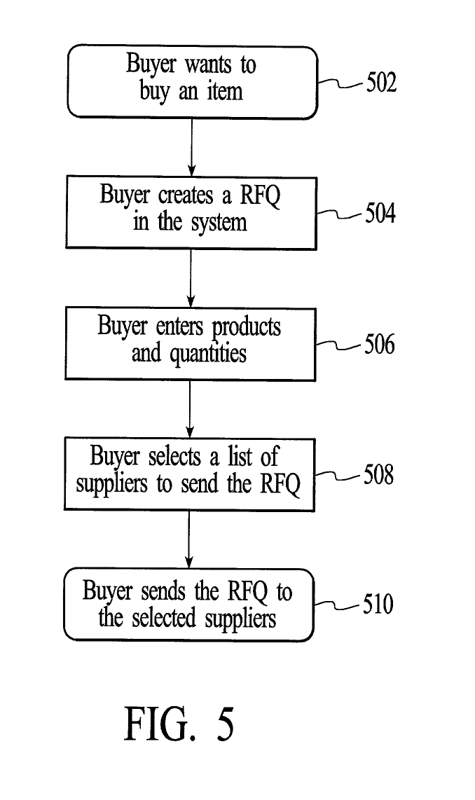

FIG. 5 is a flowchart illustrating the Request For Quotation process implemented by the RFQ Entity Beam 314 (RFQBean), RFQ Data Beans, and a RFQ business process engine in the network architecture in accordance with the present invention. First, the buyer decides he/she wants to buy an item, via step 502. The buyer 150 creates an RFQ in the system 100, via step 504. The buyer 150 enters the desired products and quantities, via step 506. Next, the buyer 150 selects a list of suppliers to send the RFQ, via step 508. The buyer then sends the RFQ to the selected suppliers, via step 510.

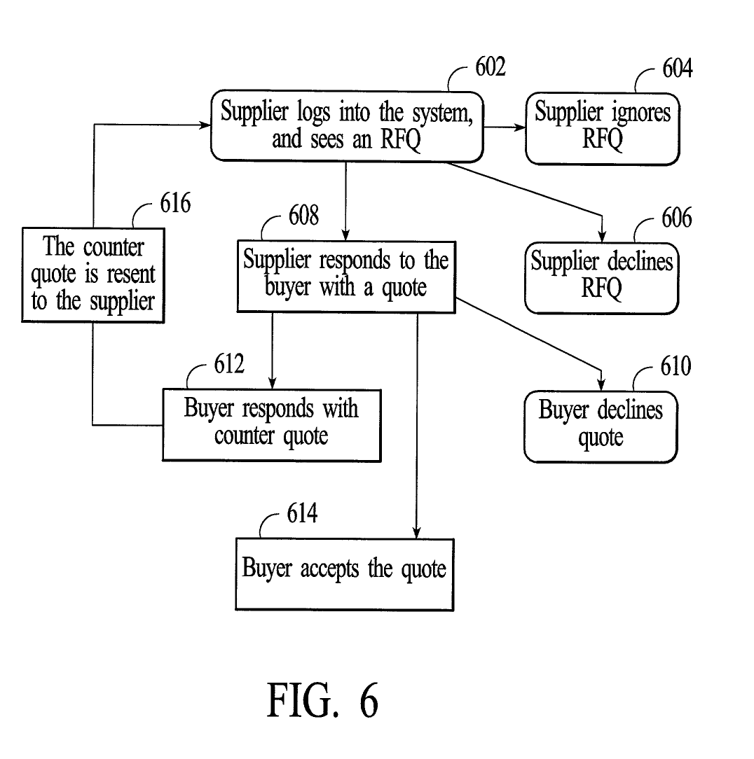

FIG. 6 is a flowchart illustrating the Quotation process implemented by the Quote Entity Bean 316 (QuoteBean), Quote Data Beans, and a Quotation business process engine in the network architecture in accordance with the present invention. First, the supplier 155 logs into the system 100 and sees an RFQ from the buyer 150, via step 602. The supplier 155 may choose to ignore the RFQ, via step 604, decline the RFQ, via step 606, or respond with a quote, via step 608. If the supplier 155 ignores the RFQ, via step 604, or declines the RFQ, via step 606, then the transaction ends. If the supplier 155 responds with a quote, via step 608, then the buyer 150 can decline the quote, via step 610, respond with a counter quote, via step 612, or accept the quote, via step 614. If the buyer 150 declines the quote, via step 610, then the transaction ends. If the buyer 150 responds with a counter quote, via step 612, then the counter quote is resent to the supplier 155, via step 616. If the buyer 150 accepts the quote, via step 614, then the Purchase Order process is implemented, as described below.

The RFQ Entity Bean 314 persists data to the database 124. All such data pertain to the Request-for-Quotation process. Essentially, it has a ‘home interface’ (RFQHome), ‘remote interface’ (RFQ), and the actual bean (RFQBean 314) implementation, as dictated by the Enterprise JavaBean specification. RFQBean 314 is a non-remote, stand-alone bean whose implementation signifies a non-distributed functionality. However, the home and remote interfaces transform the RFQBean 314 into a distributed object that may be accessed across the network by multiple clients.

The Quote Entity Bean 316 persists data pertaining to the Quotation process to the database 124. Essentially, it has a ‘home interface’ (QuoteHome), ‘remote interface’ (Quote), and the actual bean (QuoteBean 316) implementation. QuoteBean 316 is a non-remote, stand-alone bean whose implementation signifies a non-distributed functionality. However, the home and remote interfaces transform the QuoteBean 316 into a distributed object that may be accessed across the network by multiple clients.

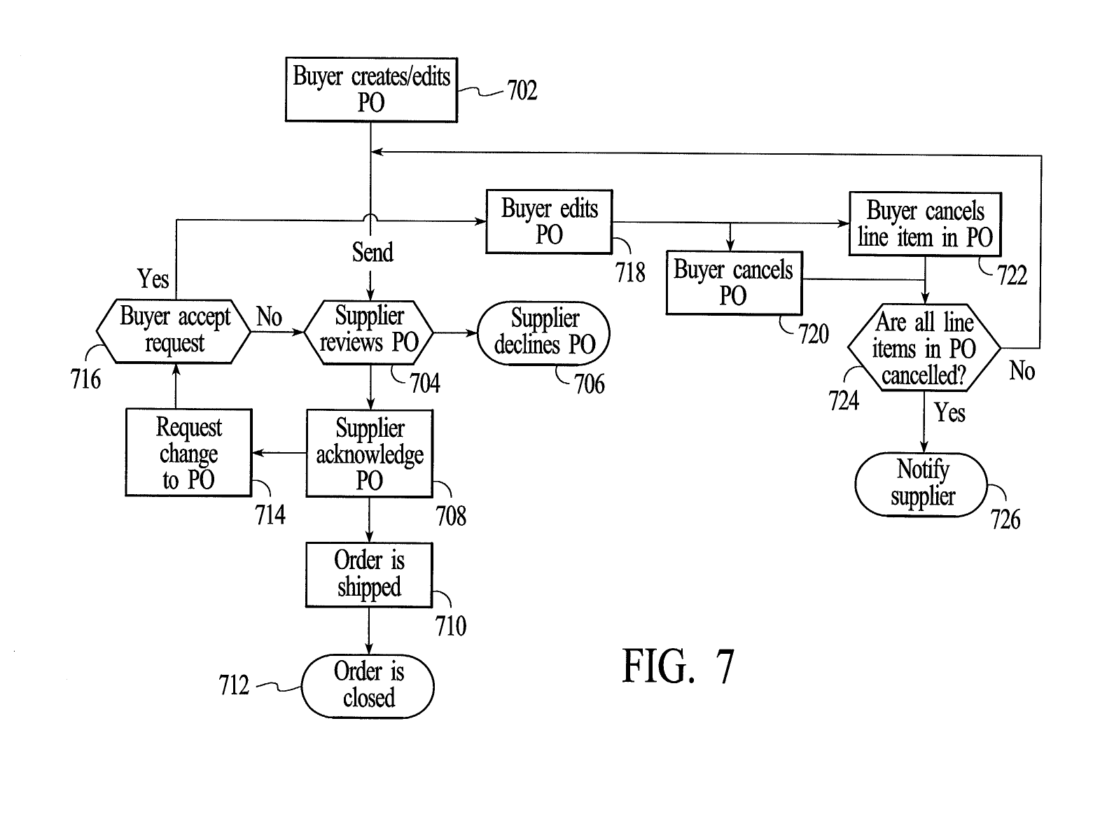

FIG. 7 is a flowchart of the Purchase Order process implemented by the PO Entity Bean 318 (POBean), PO Data Beans, and a PO business process engine in the network architecture in accordance with the present invention. Once the buyer 150 accepts the quote from the supplier 155, via step 614 (FIG. 6), the buyer 150 creates a new purchase order (PO) or edits an existing one, via step 702. The PO is then sent to the supplier 155, who reviews the PO, via step 704. The supplier 155 can decline the PO, via 706, which ends the transaction, or the supplier 155 can acknowledge the PO, via step 708. If the supplier 155 wishes to request a change to the PO, via step 714, a change request is sent to the buyer 150. If the buyer 150 rejects the change request, then the PO, as is, is sent back to the supplier 155 for his/her review, via step 704. The supplier 155 then decides again whether or not the decline the PO, via step 706, or acknowledge it, via step 708. If the buyer 150 accepts the change request, via step 716, then the buyer 150 edits the PO, via step 718, to reflect the change. The buyer can either edit by canceling the PO, via step 720, or cancel one or more line items in the PO, via step 722. If all of the line items in the PO are cancelled, via step 724, then the supplier 155 is notified of such, via step 726, and the transaction ends. If not all of the line items in the PO are cancelled, via step 724, then the revised PO is sent to the supplier 155 for review, via step 704. Once the supplier 155 acknowledges the PO, via step 708, the supplier 155 ships the order, via step 710, and closes the order, via step 712.

The PO Entity Bean 318 persists data pertaining to the Purchase Order process to the database 124. Essentially, it has a ‘home interface’ (POHome), ‘remote interface’ (PO), and the actual bean (POBean 318) implementation. POBean 318 is a non-remote, stand-alone bean whose implementation signifies a non-distributed functionality. However, the home and remote interfaces transform the POBean 318 into a distributed object that may be accessed across the network by multiple clients.

The SupplierAudit 320 and SupplierProfile 322 Entity beans persist data related to the scorecard process, as described above, and to a process for providing a supplier's profile, respectively.

Although the present invention has been described with the above EJBs, one of ordinary skill in the art will understand that other EJBs may be implemented without departing from the spirit and scope of the present invention.

For example, other EJBs may include Data Beans as information carriers. They receive data that are input by a party at a given instant. The Data Beans carry the data to the underlying business processes 312 through the Business Process Router 310. The corresponding business logic processes the data through appropriate interactions with the persistent data store. At the conclusion of all interactions, the Data Beans contain processed information, which is then conveyed to the front-end architecture 302.

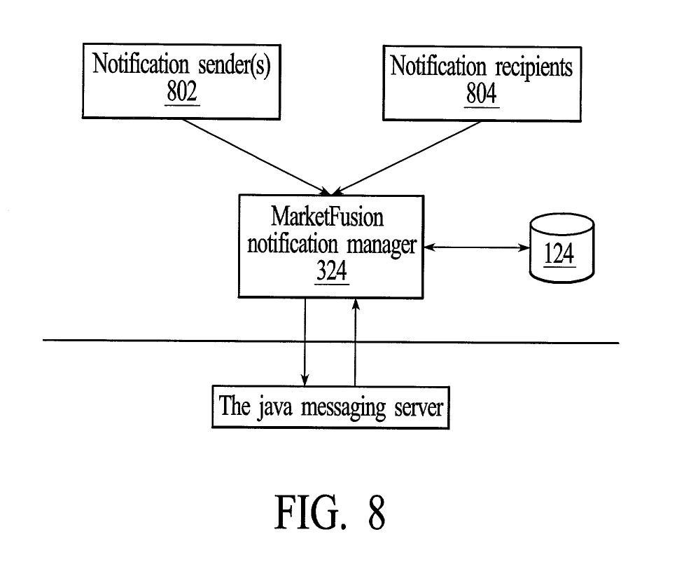

FIG. 8 illustrates a preferred embodiment of the Notification Manager in the network architecture in accordance with the present invention. In the preferred embodiment, the Notification Manager 324 is a messaging daemon, which closely monitors the messages and their corresponding notification senders 802 and notification recipients 804. In implementing such functionality, the Notification Manager 324 implements ‘deferred invocations’ to manage the messaging in an asynchronous fashion. In the preferred embodiment, the Notification Manager 324 is a custom implementation that depends on a company's database schema to record the various senders and recipients of notifications.

The notification sender 802 notifies the Notification Manager 324 on the type of message and the corresponding notification recipients 804 to whom the message is to be sent. The Notification Manager 324 then transmits the message to the notification recipients 804 as identified by the sender object. The notification recipients 804 in turn are notified through an asynchronous alert if they are logged in. In case not, the next time they log into the system, the Notification Manager 324 notifies them accordingly through proper communication with the database 124.

An implementation of a supply-based management system in a network environment has been disclosed. The supply-based management system is implemented with a front end architecture and a server side architecture. The front end architecture includes Java server pages, a controller, and a business process router. The server side architecture includes a plurality of business processes, which are implemented by a plurality of Enterprise JavaBeans, and a notification manager as a messaging daemon. The plurality of Enterprise JavaBeans implement, among others, the Request-For-Quotation, the Quotation, and the Purchase Order processes. By implementing the supply-based management system in a network environment, the efficiency of the plurality of business processes is increased.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A server for a supply-based management system, comprising:
a plurality of business process entity beans, comprising:
a request-for-quotation (RFQ) process entity bean,
a quotation process entity bean, and
a purchase order (PO) process entity bean; and
a notification manager.

2. The server of claim 1, wherein a RFQ process implemented by the RFQ entity bean comprises the steps of:
(a) creating an RFQ by a buyer;
(b) selecting a list of suppliers by the buyer; and
(c) sending the RFQ to the selected suppliers.

3. The server of claim 1, wherein a quotation process implemented by the quotation entity bean comprises the steps of:
(a) reviewing a RFQ from a buyer by a supplier; and
(b) responding to the RFQ by the supplier.

4. The server of claim 3, wherein the responding step (b) comprises:
(b1) ignoring the RFQ by the supplier.

5. The server of claim 3, wherein the responding step (b) comprises:
(b1) declining the RFQ by the supplier.

6. The server of claim 3, wherein the responding step (b) comprises:
(b1) providing a quote to the buyer by the supplier.

7. The server of claim 6, further comprising:
(b2) declining the quote by the buyer.

8. The server of claim 6, further comprising:
(b2) accepting the quote by the buyer.

9. The server of claim 6, further comprising:
(b2) providing a counter quote to the supplier by the buyer.

10. The server of claim 1, wherein a PO process implemented by the PO entity bean comprises the steps of:
(a) creating a PO by the buyer; and
(b) responding to the PO by the supplier.

11. The server of claim 10, wherein the responding step (b) comprises:
(b1) declining the PO by the supplier.

12. The server of claim 10, wherein the responding step (b) comprises:
(b1) acknowledging the PO by the supplier.

13. The server of claim 12, further comprising:
(b2) filling the PO by the supplier.

14. The server of claim 12, further comprising:
(b2) requesting a change in the PO by the supplier;
(b3) accepting the requested change by the buyer;
(b4) editing the PO by the buyer; and
(b5) sending the edited PO from the buyer to the supplier.

15. The server of claim 1, wherein the notification manager manages transmissions of messages from a sender to a recipient.

16. A supply-based management system in a network environment, comprising:
a front-end, comprising:
a user interface,
a controller coupled to the user interface, and
a business process router coupled to the controller; and
a server, comprising:
a plurality of business process entity beans, comprising:
a RFQ process entity bean,
a quotation process entity bean, and
a PO process entity bean, and
a notification manager.

17. The system of claim 16, wherein the user interface comprises a plurality of Java server pages.

18. The system of claim 16, wherein the controller controls a transfer of data between the front end and the server.

19. The system of claim 16, wherein the business process router identifies processes to which incoming data are to be passed for processing.

20. The system of claim 16, wherein a RFQ process implemented by the RFQ entity bean comprises the steps of:
(a) creating an RFQ by a buyer;
(b) selecting a list of suppliers by the buyer; and
(c) sending the RFQ to the selected suppliers.

21. The system of claim 16, wherein a quotation process implemented by the quotation entity bean comprises the steps of:
(a) reviewing a RFQ from a buyer by a supplier; and
(b) responding to the RFQ by the supplier.

22. The system of claim 21, wherein the responding step (b) comprises:
(b1) ignoring the RFQ by the supplier.

23. The system of claim 21, wherein the responding step (b) comprises:
(b1) declining the RFQ by the supplier.

24. The system of claim 21, wherein the responding step (b) comprises:
(b1) providing a quote to the buyer by the supplier.

25. The system of claim 24, further comprising:
(b2) declining the quote by the buyer.

26. The system of claim 24, further comprising:
(b2) accepting the quote by the buyer.

27. The system of claim 24, further comprising:
(b2) providing a counter quote to the supplier by the buyer.

28. The system of claim 16, wherein a PO process implemented by the PO entity bean comprises the steps of:
(a) creating a PO by the buyer; and
(b) responding to the PO by the supplier.

29. The system of claim 28, wherein the responding step (b) comprises:
(b1) declining the PO by the supplier.

30. The system of claim 28, wherein the responding step (b) comprises:
(b1) acknowledging the PO by the supplier.

31. The system of claim 30, further comprising:
(b2) filling the PO by the supplier.

32. The system of claim 30, further comprising:
(b2) requesting a change in the PO by the supplier;
(b3) accepting the requested change by the buyer;
(b4) editing the PO by the buyer; and
(b5) sending the edited PO from the buyer to the supplier.

33. The system of claim 16, wherein the notification manager manages transmissions of messages from a sender to a recipient.

34. A computer readable medium with program instructions for implementing a RFQ process for a supply-based management system, the instructions for:
(a) creating an RFQ by a buyer;
(b) selecting a list of suppliers by the buyer; and
(c) sending the RFQ to the selected suppliers.

35. A computer readable medium with program instructions for implementing a quotation process for a supply-based management system, the instructions for:
(a) reviewing a RFQ from a buyer by a supplier; and
(b) responding to the RFQ by the supplier.

36. The medium of claim 35, wherein the responding instruction (b) comprises the instructions for:
(b1) ignoring the RFQ by the supplier.

37. The medium of claim 35, wherein the responding instruction (b) comprises instructions for:
(b1) declining the RFQ by the supplier.

38. The medium of claim 35, wherein the responding instruction (b) comprises instructions for:
(b1) providing a quote to the buyer by the supplier.

39. The medium of claim 38, further comprising instructions for:
(b2) declining the quote by the buyer.

40. The medium of claim 38, further comprising instructions for:
(b2) accepting the quote by the buyer.

41. The medium of claim 38, further comprising instructions for:
(b2) providing a counter quote to the supplier by the buyer.

42. A computer readable medium with program instructions for implementing a PO process for a supply-based management system, the instructions for:
(a) creating a PO by the buyer; and
(b) responding to the PO by the supplier.

43. The medium of claim 42, wherein the responding instruction (b) comprises instructions for:
(b1) declining the PO by the supplier.

44. The medium of claim 42, wherein the responding instruction (b) comprises instructions for:
(b1) acknowledging the PO by the supplier.

45. The medium of claim 44, further comprising:
(b2) filling the PO by the supplier.

46. The medium of claim 44, further comprising:
(b2) requesting a change in the PO by the supplier;
(b3) accepting the requested change by the buyer;
(b4) editing the PO by the buyer; and
(b5) sending the edited PO from the buyer to the supplier.
